(19) United States
(12) Patent Application Publication
(10) Pub. No.: US 2010/0250260 A1
(43) Pub. Date: Sep. 30, 2010

(54) Encoder

(76) Inventors: Lasse Laaksonen, Nokia (FI); Mikko Tammi, Tampere (FI); Adriana Vasilache, Tampere (FI); Anssi Ramo, Tampere (FI)

Correspondence Address: HARRINGTON & SMITH, 4 RESEARCH DRIVE, Suite 202, SHELTON, CT, 06484-6212, US

(21) Appl. No.: 12/741,508

(22) PCT Filed: Nov. 6, 2007
(86) PCT No.: PCT/EP07/61916

§ 371 Date: Jun. 9, 2010

(51) Int. Cl. G10L 21/06

(52) U.S. Cl. 704/500; 704/E19.001

(57) ABSTRACT

A method including generating from a first audio signal, and via a first encoding and decoding of the first audio signal, a second audio signal; determining at least one energy difference value between the first audio signal and the second audio signal; and calculating at least one signal shaping factor dependent on the at least one energy difference value.

### FIELD OF THE INVENTION

The present invention relates to coding, and in particular, but not exclusively to speech or audio coding.

### BACKGROUND OF THE INVENTION

Audio signals, like speech or music, are encoded for example for enabling an efficient transmission or storage of the audio signals.

Audio encoders and decoders are used to represent audio based signals, such as music and background noise. These types of coders typically do not utilise a speech model for the coding process, rather they use processes for representing all types of audio signals, including speech.

Speech encoders and decoders (codecs) are usually optimised for speech signals, and can operate at either a fixed or variable bit rate.

An audio codec can also be configured to operate with varying bit rates. At lower bit rates, such an audio codec may work with speech signals at a coding rate equivalent to a pure speech codec. At higher bit rates, the audio codec may code any signal including music, background noise and speech, with higher quality and performance.

In some audio codecs the input signal is divided into a limited number of bands. Each of the band signals may be quantized. From the theory of psychoacoustics it is known that the highest frequencies in the spectrum are usually perceptually less important than the low frequencies. This in some audio codecs is reflected by a bit allocation where fewer bits are allocated to high frequency signals than low frequency signals.

Furthermore some codecs use the correlation between the low and high frequency bands or regions of an audio signal to improve the coding efficiency with the codecs.

As typically the higher frequency bands of the spectrum are generally quite similar to the lower frequency bands some codecs may encode only the lower frequency bands and reproduce the upper frequency bands as a scaled lower frequency band copy. Thus by only using a small amount of additional control information considerable savings can be achieved in the total bit rate of the codec.

Such techniques for coding the high frequency region are known as high frequency region (HFR) coding methods. One form of high frequency region coding is spectral-band-replication (SBR), which has been developed by Coding Technologies. In SBR, a known audio coder, such as Moving Pictures Expert Group MPEG-4 Advanced Audio Coding (AAC) or MPEG-1 Layer III (MP3) coder, codes the low frequency region. The high frequency region is generated separately utilizing the coded low frequency region.

In SBR, the high frequency region is obtained by transposing the low frequency region to the higher frequencies. The transposition is based on a Quadrature Mirror Filters (QMF) filter bank with 32 bands and is performed such that it is predefined from which band samples each high frequency band sample is constructed. This is done independently of the characteristics of the input signal.

The higher frequency bands are modified based on additional information. The modification is done to make particular features of the synthesized high frequency region more similar with the original one. Additional components, such as sinusoids or noise, are added to the high frequency region to increase the similarity with the original high frequency region. Finally, the envelope is adjusted to follow the envelope of the original high frequency spectrum.

Artefacts known as pre and post echo distortion can arise in transform codecs using perceptual coding rules. Pre-echoes occur when a signal with a sharp attack follows a section of low energy. Pre-echoes occur in such situations as a typical block based transform codec performs quantisation and encoding in the frequency domain. In order to satisfy masking thresholds associated with a perceptual measure criteria, the time-frequency uncertainty dictates that an inverse transformation will spread the quantisation distortion evenly in time throughout the reconstructed block. This results in unmasked distortion throughout the low energy region preceding in time the higher signal region in the decoded signal.

A similar effect can be perceived when there is a sudden offset in the signal. In this case the quantisation noise is spread into the subsequent low energy region after the encoded signal is transformed back into the time domain. This distortion is known as a post echo.

Pre and post echoes may be reduced by selecting a smaller window size in sections of the signal where there are transients. However, in many applications this is not always possible since a fixed delay or transform size is required. Another technique used to reduce the effect of pre/post echo distortion is Temporal Noise Shaping (TNS), whereby an adaptive predictive analysis filter is applied to the coefficients in the frequency domain. This has the effect of shaping the noise in the time domain, thereby concentrating the quantisation noise mostly into the high energy regions of the signal.

These methods have been found to be generally effective for controlling pre and post echo in coding schemes which either code the audio signal as a full band signal (in other words the whole spectrum is encoded by a single method), or the audio signal to be decoded contains a large proportion of lower frequency components, such as that found in the low band of an audio coding system employing the spilt band or SBR approach. However the signal in the upper band of a SBR approach to audio coding can exhibit very different signal characteristics to the corresponding low band and as such the methods do not produce efficient pre and post echo distortion suppression.

### SUMMARY OF THE INVENTION

This invention proceeds from the consideration that the previously described methods for controlling pre and post echo are not optimised for the high band signal characteristics in a split band or SBR approach to audio coding.

Embodiments of the present invention aim to address the above problem.

There is provided according to a first aspect of the present invention a method of encoding an audio signal comprising: generating from a first audio signal, and via a first encoding and decoding of the first audio signal, a second audio signal; determining at least one energy difference value between the first audio signal and the second audio signal; and calculating at least one signal shaping factor dependent on the at least one energy difference value.

The method may further comprise partitioning the first audio signal into a plurality of segments.

The segments are preferably at least one of: time segments; frequency segments; time and frequency segments.

Calculating the at least one signal shaping factor may comprise: comparing the at least one energy difference value for at least one of the plurality of segments of the second audio signal against a threshold value; and determining a value of the signal shaping factor associated with the at least one of the plurality of segments dependent on the result of the comparing the at least one energy difference value for at least one of the plurality of segments of the second audio signal against the threshold value.

Determining at least one energy difference value may further comprise determining at least two successive energy difference values for respective at least two successive segments of the first audio signal and at least two successive corresponding segments of the second audio signal.

Calculating at least one signal shaping factor may further comprise comparing the at least two energy difference values against a threshold in order to determine the signal shaping factor for at least one segment of the plurality of segments for the second audio signal.

The method may further comprise generating a signal shaping factor control signal dependent on the signal shaping factor for each of the plurality of segments of the second audio signal.

The energy difference value is preferably dependent on the energy of at least one segment from the first audio signal and the energy of at least one segment from the second audio signal.

The energy difference value is preferably the ratio of the energy of at least one segment of the first audio signal to the energy of at least one segment of the second audio signal.

The first audio signal is preferably an unprocessed audio signal, and wherein the second audio signal is preferably a synthetic audio signal.

The first audio signal and the second audio signal are preferably higher frequency audio signals.

According to a second aspect of the present invention there is provided a method of decoding an audio signal comprising: receiving an encoded signal comprising at least in part a signal shaping factor signal; decoding the encoded signal to produce a synthetic audio signal; determining at least one signal shaping factor the synthetic signal from the received gain factor signal; and applying the at least one signal shaping factor to the synthetic audio signal.

The method may further comprise partitioning the synthetic audio signal into a plurality of segments.

The segment is preferably at least one of: a time segment; a frequency segment; a time and frequency segment.

The determining at least one signal shaping factor may comprise determining at least one signal shaping factor for each one of the plurality of segments of the synthetic signal.

Applying the at least one signal shaping factor to the synthetic audio signal may comprise applying the at least one signal shaping factor for each one of the plurality of segments to the synthetic audio signal

Determining the at least one signal shaping factor function may comprise: decoding at least one signal shaping factor from the signal shaping factor signal; adding the at least one signal shaping factor to a track of previous at least one signal shaping factor; and interpolating the at least one signal shaping factor with the least one previous signal shaping factor from the track of signal shaping factors; and interpolating the previous signal shaping factor with the at least one signal shaping factor.

The interpolating is preferably a linear interpolating.

The interpolating is preferably a non-linear interpolating.

According to a third aspect of the invention there is provided an encoder for encoding an audio signal comprising: a first coder-decoder configured to generate from a first audio signal a second audio signal; a signal comparator configured to determine at least one energy difference value between the first audio signal and the second audio signal; a signal processor configured to calculate at least one signal shaping factor dependent on the at least one energy difference value.

The encoder may further comprise a signal partitioner configured to partition the first audio signal into a plurality of segments.

The segments are preferably at least one of: time segments; frequency segments; time and frequency segments.

The signal processor is preferably further configured to: compare the at least one energy difference value for at least one of the plurality of segments of the second audio signal against a threshold value; and determine a value of the signal shaping factor associated with the at least one of the plurality of segments dependent on the result of the comparison of the at least one energy difference value for at least one of the plurality of segments of the second audio signal against the threshold value.

The signal comparator is preferably configured to determine at least two successive energy difference values for respective at least two successive segments of the first audio signal and at least two successive corresponding segments of the second audio signal.

The signal processor is preferably further configured to compare the at least two energy difference values against a threshold in order to determine the signal shaping factor for at least one segment of the plurality of segments for the second audio signal.

The signal processor is preferably further configured to generate a signal shaping factor control signal dependent on the signal shaping factor for each of the plurality of segments of the second audio signal.

The energy difference value is preferably dependent on the energy of at least one segment from the first audio signal and the energy of at least one segment from the second audio signal.

The energy difference value is preferably the ratio of the energy of at least one segment of the first audio signal to the energy of at least one segment of the second audio signal.

The first audio signal is preferably an unprocessed audio signal, and wherein the second audio signal is preferably a synthetic audio signal.

The first audio signal and the second audio signal are preferably higher frequency audio signals.

According to a fourth aspect of the present invention there is provided a decoder for decoding an audio signal configured to: receive an encoded signal comprising at least in part a signal shaping factor signal; decode the encoded signal to produce a synthetic audio signal; determine at least one signal shaping factor for the synthetic signal from the received signal shaping factor signal; and apply the at least one signal shaping factor to the synthetic audio signal.

The decoder may be further configured to partition the synthetic audio signal into a plurality of segments.

The segments are at least one of: time segments; frequency segments; time and frequency segments.

The decoder is preferably configured to determine the at least one signal shaping factor by determining at feast one signal shaping factor for each one of the plurality of segments of the synthetic signal.

The decoder is preferably configured to apply the at least one signal shaping factor to the synthetic audio signal by applying the at least one signal shaping factor for each one of the plurality of segments to the synthetic audio signal

The decoder is preferably configured to determine the at least one signal shaping factor function by: decoding at least one signal shaping factor from the signal shaping factor signal; adding the at least one signal shaping factor to a track of previous at least one signal shaping factor; interpolating the at least one signal shaping factor with the least one previous signal shaping factor from the track of signal shaping factors; and interpolating the previous signal shaping factor with the at least one signal shaping factor.

The interpolating is preferably a linear interpolation.

The interpolating is preferably a non-linear interpolation.

Apparatus may comprise an encoder as described above.

Apparatus may comprise a decoder as described above.

An electronic device may comprise an encoder as described above.

An electronic device may comprise a decoder as described above.

According to a fifth aspect of the present invention there is provided a computer program product configured to perform a method for encoding an audio signal comprising: generating from a first audio signal, and via a first encoding and decoding of the first audio signal, a second audio signal; determining at least one energy difference value between the first audio signal and the second audio signal; and calculating at least one signal shaping factor dependent on the at least one energy difference value.

According to a sixth aspect of the present invention there is provided a computer program product configured to perform a method for decoding an audio signal comprising: receiving an encoded signal comprising at least in part a signal shaping factor signal; decoding the encoded signal to produce a synthetic audio signal; determining at least one signal shaping factor the synthetic signal from the received gain factor signal; and applying the at least one signal shaping factor to the synthetic audio signal.

According to a seventh aspect of the present invention there is provided an encoder for encoding an audio signal comprising: codec means for generating from a first audio signal a second audio signal; first signal processing means configured to determine at least one energy difference value between the first audio signal and the second audio signal; second signal processing means configured to calculate at least one signal shaping factor dependent on the at least one energy difference value.

According to an eighth aspect of the present invention there is provided a decoder for decoding an audio signal, comprising: receiving means for accepting an encoded signal comprising at least in part a signal shaping factor signal; decoding means for decoding the encoded signal to produce a synthetic audio signal; first signal processing means for determining at least one signal shaping factor for the synthetic signal from the received signal shaping factor signal; and second signal processing means for applying the at least one signal shaping factor to the synthetic audio signal.

### BRIEF DESCRIPTION OF DRAWINGS

For better understanding of the present invention, reference will now be made by way of example to the accompanying drawings in which:

FIG. 1 shows schematically an electronic device employing embodiments of the invention;

FIG. 2 shows schematically an audio codec system employing embodiments of the present invention;

FIG. 3 shows schematically an encoder part of the audio codec system shown in FIG. 2;

FIG. 4 shows schematically a decoder part of the audio codec system shown in FIG. 2;

FIG. 5 shows an example of gain track interpolation as employed in embodiments of the invention;

FIG. 6 shows a flow diagram illustrating the operation of an embodiment of the audio encoder as shown in FIG. 3 according to the present invention; and

FIG. 7 shows a flow diagram illustrating the operation of an embodiment of the audio decoder as shown in FIG. 3 according to the present invention.

### DESCRIPTION OF PREFERRED EMBODIMENTS OF THE INVENTION

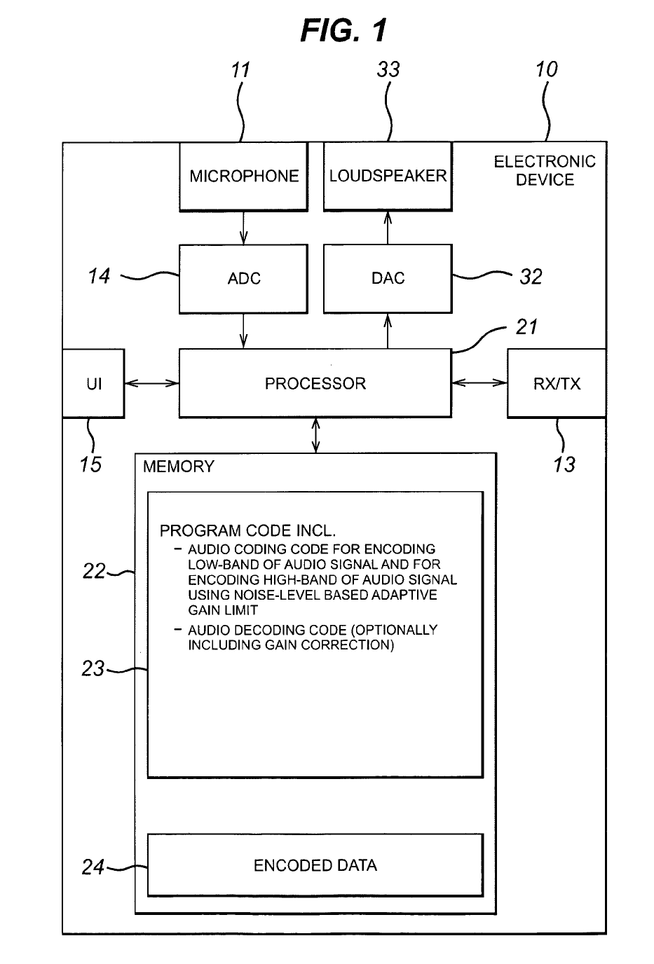

The following describes in more detail possible apparatus and mechanisms for the provision of pre and post echo control in a high band signal component of an audio codec. In this regard reference is first made to FIG. 1 schematic block diagram of an exemplary electronic device 10, which may incorporate a codec according to an embodiment of the invention.

The electronic device 10 may for example be a mobile terminal or user equipment of a wireless communication system.

The electronic device 10 comprises a microphone 11, which is linked via an analogue-to-digital converter 14 to a processor 21. The processor 21 is further linked via a digital-to-analogue converter 32 to loudspeakers 33. The processor 21 is further linked to a transceiver (TX/RX) 13, to a user interface (UI) 15 and to a memory 22.

The processor 21 may be configured to execute various program codes. The implemented program codes comprise an audio encoding code for encoding a lower frequency band of an audio signal and a higher frequency band of an audio signal. The implemented program codes 23 further comprise an audio decoding code. The implemented program codes 23 may be stored for example in the memory 22 for retrieval by the processor 21 whenever needed. The memory 22 could further provide a section 24 for storing data, for example data that has been encoded in accordance with the invention.

The encoding and decoding code may in embodiments of the invention be implemented in hardware or firmware.

The user interface 15 enables a user to input commands to the electronic device 10, for example via a keypad, and/or to obtain information from the electronic device 10, for example via a display. The transceiver 13 enables a communication with other electronic devices, for example via a wireless communication network.

It is to be understood again that the structure of the electronic device 10 could be supplemented and varied in many ways.

A user of the electronic device 10 may use the microphone 11 for inputting speech that is to be transmitted to some other electronic device or that is to be stored in the data section 24 of the memory 22. A corresponding application has been activated to this end by the user via the user interface 15. This application, which may be run by the processor 21, causes the processor 21 to execute the encoding code stored in the memory 22.

The analogue-to-digital converter 14 converts the input analogue audio signal into a digital audio signal and provides the digital audio signal to the processor 21.

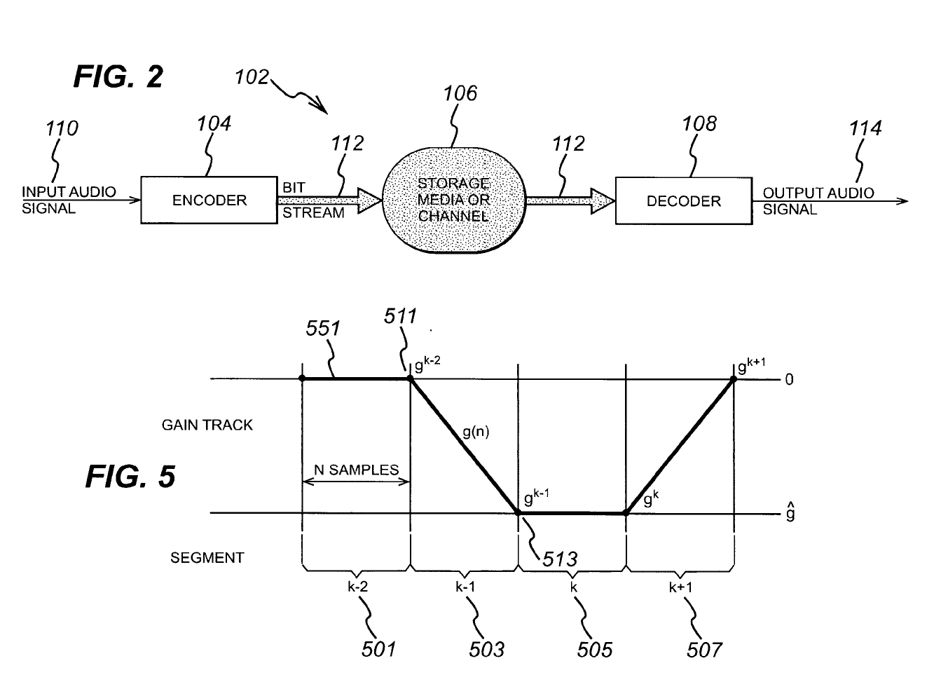

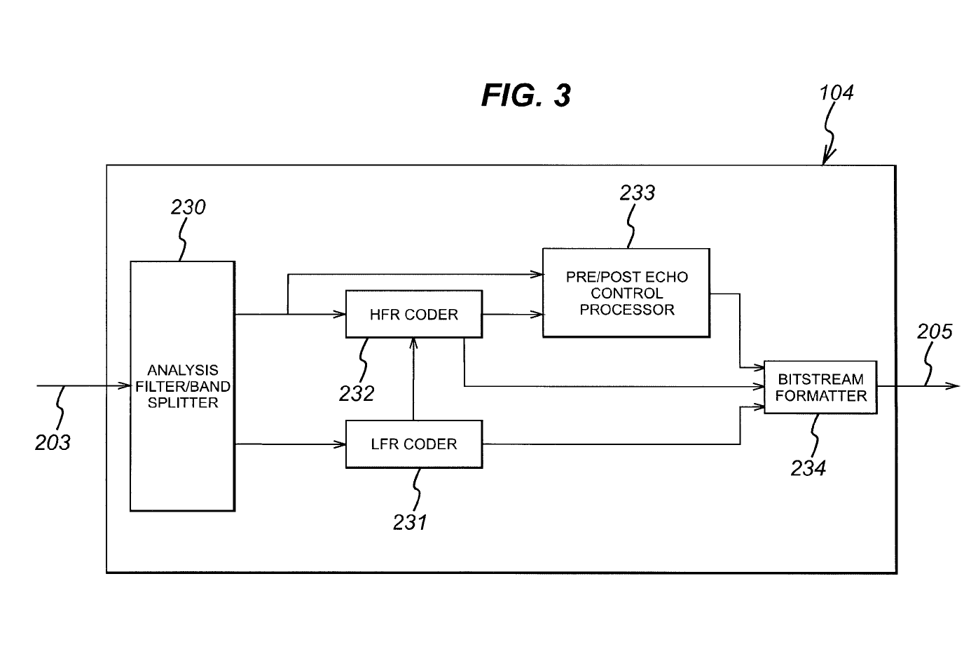

The processor 21 may then process the digital audio signal in the same way as described with reference to FIGS. 2 and 3.

The resulting bit stream is provided to the transceiver 13 for transmission to another electronic device. Alternatively, the coded data could be stored in the data section 24 of the memory 22, for instance for a later transmission or for a later presentation by the same electronic device 10.

The electronic device 10 could also receive a bit stream with correspondingly encoded data from another electronic device via its transceiver 13. In this case, the processor 21 may execute the decoding program code stored in the memory 22. The processor 21 decodes the received data, and provides the decoded data to the digital-to-analogue converter 32. The digital-to-analogue converter 32 converts the digital decoded data into analogue audio data and outputs them via the loudspeakers 33. Execution of the decoding program code could be triggered as well by an application that has been called by the user via the user interface 15.

The received encoded data could also be stored instead of an immediate presentation via the loudspeakers 33 in the data section 24 of the memory 22, for instance for enabling a later presentation or a forwarding to still another electronic device.

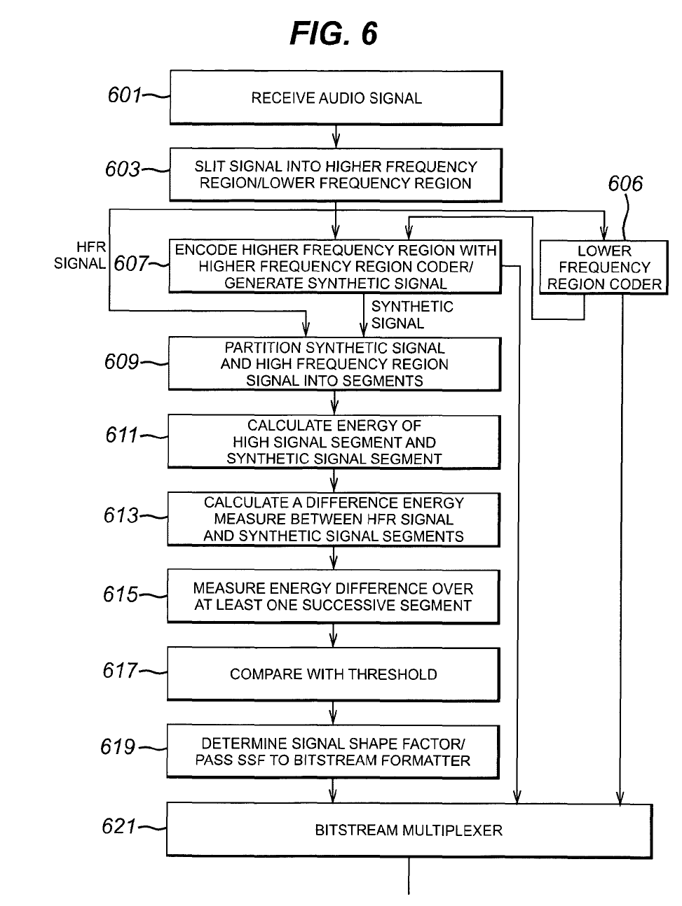

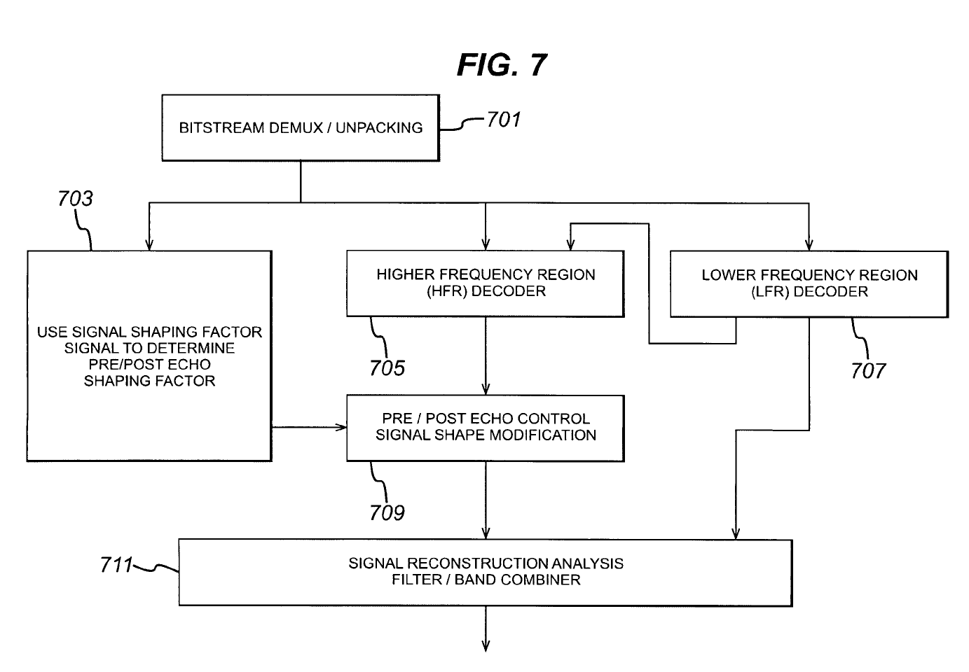

It would be appreciated that the schematic structures described in FIGS. 2 to 4 and the method steps in FIGS. 6 and 7 represent only a part of the operation of a complete audio codec as exemplarily shown implemented in the electronic device shown in FIG. 1.

The general operation of audio codecs as employed by embodiments of the invention is shown in FIG. 2. General audio coding/decoding systems consist of an encoder and a decoder, as illustrated schematically in FIG. 2. Illustrated is a system 102 with an encoder 104, a storage or media channel 106 and a decoder 108.

The encoder 104 compresses an input audio signal 110 producing a bit stream 112, which is either stored or transmitted through a media channel 106. The bit stream 112 can be received within the decoder 108. The decoder 108 decompresses the bit stream 112 and produces an output audio signal 114. The bit rate of the bit stream 112 and the quality of the output audio signal 114 in relation to the input signal 110 are the main features, which define the performance of the coding system 102.

FIG. 3 shows schematically an encoder 104 according to an embodiment of the invention. The encoder 104 comprises an input 203 arranged to receive an audio signal.

The input 203 is connected to a band splitter 230, which divides the signal into an upper frequency band (also known as a higher frequency region) and a lower frequency band (also known as a lower frequency region). The lower frequency band output from the band splitter is connected to the lower frequency region coder (otherwise known as the core codec) 231. The lower frequency region coder 231 is further connected to the higher frequency region coder 232 and is configured to pass information about the coding of the lower frequency region for the higher frequency region coding process.

The higher frequency band output from the band splitter is arranged to be connected to the higher frequency region (HFR) coder 232. The HFR coder is configured to output a synthetic audio signal which is arranged to be connected to the input of the pre/post echo control processor, 233.

In addition to receiving an input from the HFR coder the pre/post echo control processor 233 is further arranged to receive, as an additional input, the original higher frequency band signal as outputted from the band splitter 230.

The lower frequency region (LFR) coder 231, the HFR coder, 232 and the pre/post echo control processor are configured to output signals to the bitstream formatter 234 (which in some embodiments of the invention is also known as the bitstream multiplexer). The bitstream formatter 234 is configured to output the output bitstream 112 via the output 205.

The operation of these components is described in more detail with reference to the flow chart shown in FIG. 6 showing the operation of the encoder 104.

The audio signal is received by the encoder 104. In a first embodiment of the invention the audio signal is a digitally sampled signal. In other embodiments of the present invention the audio input may be an analogue audio signal, for example from a microphone 6, which is analogue to digitally (A/D) converted. In further embodiments of the invention the audio input is converted from a pulse code modulation digital signal to amplitude modulation digital signal. The receiving of the audio signal is shown in FIG. 6 by step 601.

The band splitter 230 receives the audio signal and divides the signal into a higher frequency band signal and a lower frequency band signal. In some embodiments of the present invention the dividing of the audio signal into higher frequency and lower frequency band signals may take the form of low pass filtering (to produce the lower frequency band signal) and high pass filtering (to produce the higher frequency band signal) of the audio signal in order to effectuate the division of the signal into bands.

Typically the process may be followed by a down sampling stage of the respective filtered signals in order to achieve two base band signals. For example, a down sampling factor of two may be used in order to achieve two base band signals of equal bandwidth.

In further embodiments of the present invention the splitting of the signal may be effectuated by utilising a quadrature mirror filter (QMF) structure whereby the aliasing components introduced by the analysis filtering stage are effectively cancelled by each other when the signal is reconstructed at the synthesis stage in the decoder.

This division of the signal into higher frequency and lower frequency band signals is shown in FIG. 6, by step 603.

The lower frequency region (LFR) coder 231 as described above receives the lower frequency band (and optionally down sampled) audio signal and applies a suitable low frequency coding upon the signal. In an embodiment of the invention the lower frequency region coder 231 may apply quantisation and Huffman coding to sub-bands of the lower frequency region audio signal. The input signal 110 to the lower frequency region coder 231 may in these embodiments be divided into sub-bands using an analysis filter bank structure. Each sub-band may be quantized and coded utilizing the information provided by a psychoacoustic model. The quantisation settings as well as the coding scheme may be chosen dependent on the psychoacoustic model applied.

The quantised, coded information is sent to the bit stream formatter 234 for creating a bit stream 112.

Furthermore, the low frequency coder 231 provides a frequency domain realization of synthesized LFR signal. This realization may be passed to the HFR coder 232, in order to effectuate the coding of the higher frequency region.

This lower frequency coding is shown in FIG. 6 by step 606.

In other embodiments of the invention other low frequency codecs may be employed in order to generate the core coding output which is output to the bitstream formatter 234. Examples of these further embodiment low frequency codecs include but are not limited to advanced audio coding (AAC), MPEG layer 3 (MP3), the ITU-T Embedded variable rate (EV-VRR) speech coding baseline codec, and ITU-T G.729.1.

The higher frequency band signal output from the band splitter, 230, may then be received by the high frequency region (HFR) coder, 232. In a first embodiment of the present invention this higher frequency band signal may be encoded with a spectral band replication type algorithm, where spectral information from the coding of the lower frequency band is used to replicate the higher frequency band spectral structure. In further embodiments of the present invention this higher frequency band signal may be encoded with a higher frequency region coder that may solely act on the higher frequency band signal to be encoded and does not employ information from the lower frequency band to assist in the process.

This high frequency region coding stage is exemplary depicted by step 607, in FIG. 6.

As part of the higher frequency band encoding process, the codec may produce a synthetic audio signal output. This is a representation or estimation of the decoded signal but produced locally at the encoder. In an exemplary embodiment of the present invention this higher frequency band synthetic signal may be divided into segments along with the original higher frequency band signal. The length of the segment may be arbitrarily chosen, but typically it will be related to the sampling frequency of the signal. This segmentation of the original and synthetic signals is depicted by step 609 in FIG. 6.

The pre/post echo control processor 233 may determine an energy value of each segment for the synthetic and original higher frequency band signals. This stage is represented in FIG. 7 by step 611.

Furthermore the pre/post echo control processor 233 may determine a measure of the relative difference in energy between corresponding segments of the synthetic and original signals using the determined energy values of each segment for the synthetic and original higher frequency band signals. This determination of the measure of the relative difference in energy stage is represented in FIG. 6 by step 613.

The pre/post echo control processor 233 may also in embodiments of the invention track the determined measure of relative difference in the energy for the synthetic and original higher frequency band signals across successive segments and compare the determined measure against a predetermined threshold value in order to ascertain if there is a discrepancy between the original and synthetic signals due to pre or post echo. This tracking process is shown in FIG. 6 by step 617.

The pre/post echo control processor 233 may then pass information regarding the comparison of the energy difference against the threshold value for each segment to the bit stream formatter 234. This is shown in FIG. 6 by step 619.

The bitstream formatter 234 receives the low frequency coder 231 output, the high frequency region coder 232 output and the selection output from the pre/post echo control processor 233 and formats the bitstream to produce the bitstream output. The bitstream formatter 234 in some embodiments of the invention may interleave the received inputs and may generate error detecting and error correcting codes to be inserted into the bitstream output 112.

In the embodiment described hereafter the encoding of the present invention is exemplarily described with respect to a specific example, but it is to be understood that this example is not limiting and is included to enhance the understanding of the invention.

In this exemplary embodiment of the present invention of the encoder x_{orig}(n) is the original higher frequency band signal, and x_{syn}(n) is the locally generated higher frequency band synthesized version. Initially both signals may be divided into segments of length N samples. For example a suitable length of segment was found to be 2.5 ms, and which for a 32 kHz sampled signal results in an analysis frame length of 80 samples. However, it is to be understood other embodiments of the present invention may implement the invention with segments of different length.

In this example the k′th segment of the original and synthesized signals are denoted as x_{orig}^{k}(n) and x_{syn}^{k}(n), where nε0, . . . , N−1, respectively.

Furthermore the pre/post echo control processor 233 may determine an energy value of each segment for the synthetic and original higher frequency band signals according to mean square value of each sample. Thus

$${E}_{orig}^{k} = \frac{1}{N} {\sum }_{n = 0}^{N - 1} {( {x}_{orig}^{k} ( n ) )}^{2} , \\ {E}_{syn}^{k} = \frac{1}{N} {\sum }_{n = 0}^{N - 1} {( {x}_{syn}^{k} ( n ) )}^{2} .$$

where E_{orig} is the energy for the original higher frequency band signal and E_{syn} is the energy for the synthetic higher frequency band signal. However, it is to be understood that further embodiments of the present invention may use different energy measures, for example a non limiting list may include; the root mean square value (RMS) or the mean of the magnitude of the band signal.

The pre/post echo control processor 233 may determine the relative difference in energy between corresponding segments of the synthetic and original signals by determining the ratio of the respective energies. Thus in this example the relative difference for the k′th segment metric d^{k} is given by:

$${d}^{k} = \frac{{E}_{orig}^{k}}{{E}_{syn}^{k}} .$$

It is to be understood, however, that other difference energy metrics may be employed in further embodiments for the present invention. For example some embodiments may implement the difference energy metric as a simple difference, such as the difference of the magnitude of the energies.

The pre/post echo control processor 233 may then track the difference energy metric d^{k} across segments and define a logarithmic domain gain parameter g^{k} dependent on the segment difference energy metric with respect to the predefined difference energy threshold a based on the energy ratios in two successive segments. The logic presented in table 1 may then be used in the determination of g^{k}.

Table 1 exemplarily depicts a pseudo code logic for obtaining gain values g^{k} in an embodiment of the present invention.

```
For every k :
If (d^{k} < \hat{d} and d^{k-1} < \hat{d}){
  g^{k} = ĝ
  g^{k-1} = ĝ
} else {
  g^{k} = 0
}
```

Typically for embodiments of the invention \hat{d} and ĝ are experimentally chosen values. Also ĝ may, in some embodiments of the invention, be selected to be a negative value. It is to be noted, in this embodiment of the invention, that if both the current energy difference metric d^{k} and the previous energy difference metric d^{k-1} are below \hat{d}, then the value of the gain parameter of the previous segment, g^{k-1}, is also modified.

In this particular embodiment of the invention g^{k} may only be one of two values. Thus in this example only one bit may be submitted to the decoder in order to describe the value of g^{k} in a segment k.

An advantage thus in embodiments of the invention such as described above is that this improvement only requires a very low additional bit rate over previous methods of controlling pre and post echo.

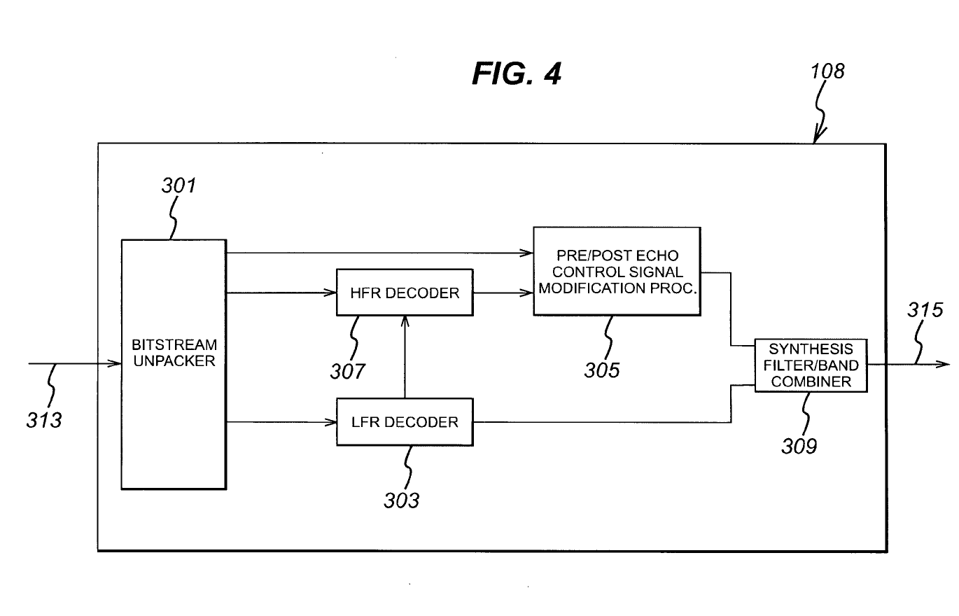

To further assist the understanding of the invention the operation of the decoder 108 with respect to the embodiments of the invention is shown with respect to the decoder schematically shown in FIG. 4 and the flow chart showing an example of the operation of the decoder in FIG. 7.

The decoder comprises an input 313 from which the encoded bitstream 112 may be received. The input 313 is connected to the bitstream unpacker 301.

The bitstream unpacker demultiplexes, partitions, or unpacks the encoded bitstream 112 into three separate bitstreams. The lower frequency region encoded bitstream is passed to the lower frequency region decoder 303, the higher frequency region encoded bitstream is passed to the higher, frequency region reconstructor/decoder 307 (also known as a high frequency region decoder) and the echo control bitstream is passed to the echo control signal modification processor 305.

This unpacking process is shown in FIG. 7 by step 701.

The lower frequency region decoder 303 receives the lower frequency region encoded data and constructs a synthesized lower frequency signal by performing the inverse process to that performed in the lower frequency region coder 231. If the higher frequency region codec employs a SBR type algorithm then this synthesized lower frequency region signal may be passed to the higher frequency region decoder/reconstructor 307. In addition the synthetic output of the lower frequency region decoder may be further arranged to form one of the inputs to the band combiner/synthesis filter, 309.

This lower frequency region decoding process is shown in FIG. 7 by step 707.

The higher frequency region decoder or reconstructor 307, on receiving the higher frequency region encoded data constructs a synthesised high frequency signal by performing the inverse process to that performed in the higher frequency region coder 232.

The higher frequency region construction or decoding is shown in FIG. 7 by step 705.

The output of the higher frequency region decoder is then arranged to be passed to the pre/post echo control signal modification unit 305. On receiving the higher frequency region synthesised signal, the echo signal modification unit will parse the echo control bit stream, and for each corresponding segment of the synthesised signal determine if the time envelope of the segment requires modification by a gain factor.

In addition, in some embodiments of the invention interpolation may be applied to the gain factor across the length of the segment, if the signal modification gain is deemed to change at the boundaries of the said segment. The variable gain function, as well as the previously described gain, may also be known as a signal shaping function as it produces a signal shaping effect. The signal shaping function when applied may have the effect of smoothing out any energy transitions in the time envelope window from one segment to the next. In some embodiments of the present invention it may be necessary to monitor the signal modification gain track from one segment to the next in order to determine the exact signal shaping function to be applied across the segment.

The process of determining if a particular segment requires echo control modification is depicted by step 703 in FIG. 7. The mechanism of deploying signal modification to the synthesised higher frequency region signal is further depicted by step 709 in FIG. 7.

The signal reconstruction processor 309 receives the decoded lower frequency region signal and the decoded or reconstructed higher frequency region signal, and forms a full band or spectral signal by using the inverse of the process used to split the signal spectrum into two bands or regions at the encoder, as exemplary depicted by 230. In some embodiments of the present invention this may be achieved by using a synthesis filter bank structure if the equivalent analysis bank is employed at the encoder. An example of such an analysis synthesis filter bank structure may be a QMF filter bank.

This reconstruction of the signal into a full band signal is shown in FIG. 7 by step 711.

In an example of an embodiment of the present invention the gain parameters g^{k} may be arranged to form a gain track g(n) (a signal shaping factor) at the decoder. If the gain/signal shaping factor value was then seen to change at the segment boundaries linear interpolation may be used in order to smooth out the gain transition as the segment is traversed. This is exemplary depicted in FIG. 5. In the example shown in FIG. 5 a gain track g(n) 551 is shown for a series of consecutive segments. There is shown 4 segments, the k−2 segment 501, the k−1 segment 503 the k segment 505 and the k+1 segment 507. In the example shown the k−2 segment 501 has as signal shaping factor of 0 and the k segment 505 has a signal shaping factor of 0. The intermediate segment, in order that there is a gradual change from the k−2 segment to the k segment has applies a linear transform to the gain function to each of the samples in the k−1 sample. In other words the first sample in the k−1 segment 503 has a value near the value of the k−2 segment last sample 511 and the value of the k−1 segment last sample 513 has a value near to the value of the first sample of the k segment 505.

It is to be understood that in further embodiments of the invention that different interpolation schemes may be adopted. For example, it may be possible to adopt a non linear scheme.

The synthesized signal x_{syn}(n) may then be modified by using the gain track/signal shaping factor g(n). Should a logarithmic gain parameter be used, then the higher frequency region synthetic signal may be modified as follows.

\hat{x}_{syn}(n)=x_{syn}(n)10^{g(n)},

where \hat{x}_{syn}(n) is the modified synthesized signal. Further, in this exemplary embodiment of the invention it may be noted that when g(n) is zero, there is no energy difference between original and synthesized signals, and \hat{x}_{syn}(n) is equal to x_{syn}(n).

In one embodiment of the invention the temporal envelope shaping technique may be used to control the pre and post echo for a higher frequency region synthesised signal for frequencies within the region of 7 kHz to 14 kHz, and where the overall sampling frequency of the codec is 32 kHz. For this particular example, the higher frequency region codec utilises a frame size of 20 ms or 640 samples. The frame may be divided into 8 segments where each segment may be a length of 80 samples. At the encoder the fixed values may be selected to be:

d^{k}=0.2

ĝ=−0.5

Since there are 8 segments per frame, 8 bits may be used in order to represent the echo control information for the frame. For this particular example of an embodiment of the present invention the echo control information would only result in an overhead of 0.4 kbits/sec.

One advantage of this invention is that it provides an efficient, low complexity and low bit rate solution to the problem of echo control temporal envelope shaping. The method was found to be especially suitable for those audio codec architectures which deploy high band coding at a frequency range greater than 7 kHz.

Although the above embodiments have been described in terms of a split frequency region/band architecture whereby the signal has been divided into a higher frequency region and a lower frequency region, it is to be understood that further embodiments of the present invention may be deployed with different numbers of split frequency regions in different coding architectures.

For example each of the lower and higher frequency regions may be further subdivided into sub-regions or sub-bands and a lower frequency sub-band associated with a higher frequency sub-band. In such embodiments of the invention the associated sub-bands are compared and the gain factor/shaping factors are determined for each sub-band of each segment. Although this further division increases the information having to be passed from the encoder to the decoder it results in signal shaping factors being targeted to assist in the reduction of echo errors.

In further embodiments of the invention it may be possible to examine each signal segment across the full band of the signal thereby removing the need for a mechanism to divide the signal into multiple bands. This for example may be further advantageous if the signal characteristics exhibit features which may typically be found in a high band. One example of these features may occur if the signal is unstructured and noise like, such as that found in an unvoiced sound.

The embodiments of the invention described above describe the codec in terms of separate encoders 104 and decoders 108 apparatus in order to assist the understanding of the processes involved. However, it would be appreciated that the apparatus, structures and operations may be implemented as a single encoder-decoder apparatus/structure/operation. Furthermore in some embodiments of the invention the coder and decoder may share some/or all common elements.

Although the above examples describe embodiments of the invention operating within a codec within an electronic device 610, it would be appreciated that the invention as described below may be implemented as part of any variable rate/adaptive rate audio (or speech) codec. Thus, for example, embodiments of the invention may be implemented in an audio codec which may implement audio coding over fixed or wired communication paths.

Thus user equipment may comprise an audio codec such as those described in embodiments of the invention above.

It shall be appreciated that the term user equipment is intended to cover any suitable type of wireless user equipment, such as mobile telephones, portable data processing devices or portable web browsers.

Furthermore elements of a public land mobile network (PLMN) may also comprise audio codecs as described above.

In general, the various embodiments of the invention may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Further in this regard it should be noted that any blocks of the logic flow as in the Figures may represent program steps, or interconnected logic circuits, blocks and functions, or a combination of program steps and logic circuits, blocks and functions.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs) and processors based on multi-core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

Programs, such as those provided by Synopsys, Inc. of Mountain View, Calif. and Cadence Design, of San Jose, Calif. automatically route conductors and locate components on a semiconductor chip using well established rules of design as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

The foregoing description has provided by way of exemplary and non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims.

1. A method comprising:
generating from a first audio signal, and via a first encoding and decoding of the first audio signal, a second audio signal;
determining at least one energy difference value between the first audio signal and the second audio signal; and
calculating at least one signal shaping factor dependent on the at least one energy difference value.

2. The method as claimed in claim 1, further comprising:
partitioning the first audio signal into a plurality of segments.

3. The method as claimed in claim 2,
wherein the segments are at least one of:
time segments;
frequency segments;
time and frequency segments.

4. The method as claimed in claim 2, wherein calculating the at least one signal shaping factor comprises:
comparing the at least one energy difference value for at least one of the plurality of segments of the second audio signal against a threshold value; and
determining a value of the signal shaping factor associated with the at least one of the plurality of segments dependent on the result of the comparing the at least one energy difference value for at least one of the plurality of segments of the second audio signal against the threshold value.

5. The method as claimed in claim 2, wherein determining at least one energy difference value further comprises:
determining at least two successive energy difference values for respective at least two successive segments of the first audio signal and at least two successive corresponding segments of the second audio signal.

6. The method as claimed in claim 5, wherein the calculating at least one signal shaping factor further comprises
comparing the at least two energy difference values against a threshold in order to determine the signal shaping factor for at least one segment of the plurality of segments for the second audio signal.

7. The method as claimed in claim 2, the method further comprises generating a signal shaping factor control signal dependent on the signal shaping factor for each of the plurality of segments of the second audio signal.

8. The method as claimed in claim 2, wherein the energy difference value is dependent on the energy of at least one segment from the first audio signal and the energy of at least one segment from the second audio signal.

9. The method as claimed in claim 8, wherein the energy difference value is the ratio of the energy of at least one segment of the first audio signal to the energy of at least one segment of the second audio signal.

10. The method as claimed in claim 1, wherein the first audio signal is an unprocessed audio signal, and wherein the second audio signal is a synthetic audio signal.

11. The method as claimed in claim 1, wherein the first audio signal and the second audio signal are higher frequency audio signals.

12. A method comprising:
receiving an encoded signal comprising at least in part a signal shaping factor signal;
decoding the encoded signal to produce a synthetic audio signal;
determining at least one signal shaping factor the synthetic signal from the received gain factor signal; and
applying the at least one signal shaping factor to the synthetic audio signal.

13. The method as claimed in claim 12, further comprising: partitioning the synthetic audio signal into a plurality of segments.

14. The method as claimed in claim 13, wherein the segment is at least one of:
a time segment;
a frequency segment;
a time and frequency segment.

15. The method as claimed in claim 13, wherein the determining at least one signal shaping factor comprises determining at least one signal shaping factor for each one of the plurality of segments of the synthetic signal.

16. The method as claimed in claim 13, wherein applying the at least one signal shaping factor to the synthetic audio signal comprises applying the at least one signal shaping factor for each one of the plurality of segments to the synthetic audio signal.

17. The method as claimed in claim 12, wherein determining the at least one signal shaping factor function comprises:
decoding at least one signal shaping factor from the signal shaping factor signal;
adding the at least one signal shaping factor to a track of previous at least one signal shaping factor; and
interpolating the at least one signal shaping factor with the least one previous signal shaping factor from the track of signal shaping factors; and interpolating the previous signal shaping factor with the at least one signal shaping factor.

18-46. (canceled)

47. An apparatus comprising:
at least one processor and at least one memory including computer program code, the at least one memory and the computer program code configured to, with the at least one processor, cause the apparatus at least to:
generate from a first audio signal, and via a first encoding and decoding of the first audio signal, a second audio signal;
determine at least one energy difference value between the first audio signal and the second audio signal; and
calculate at least one signal shaping factor dependent on the at least one energy difference value.

48. The apparatus as claimed in claim 47, wherein the at least one memory and the computer program code are further configured to, with the at least one processor, cause the apparatus at least to:
partition the first audio signal into a plurality of segments.

49. The apparatus as claimed in claim 48, wherein the segments are at least one of:
time segments;
frequency segments;
time and frequency segments.

50. The apparatus as claimed in claim 48, wherein the at least one memory and the computer program code configured to, with the at least one processor, cause the apparatus at least to calculate at least one signal shaping factor is further configured to cause the apparatus at least to:
compare the at least one energy difference value for at least one of the plurality of segments of the second audio signal against a threshold value; and
determine a value of the signal shaping factor associated with the at least one of the plurality of segments dependent on the result of the comparison of the at least one energy difference value for at least one of the plurality of segments of the second audio signal against the threshold value.

51. The apparatus as claimed in claim 48, wherein the at least one memory and the computer program code configured to, with the at least one processor, cause the apparatus at least to determine at least one energy difference value is further configured to cause the apparatus at least to:
determine at least two successive energy difference values for respective at least two successive segments of the first audio signal and at least two successive corresponding segments of the second audio signal.

52. The apparatus as claimed in claim 51, wherein the at least one memory and the computer program code configured to, with the at least one processor, cause the apparatus at least to calculate at least one signal shaping factor is further configured to cause the apparatus at least to:
compare the at least two energy difference values against a threshold in order to determine the signal shaping factor for at least one segment of the plurality of segments for the second audio signal.

53. The apparatus as claimed in claim 48, wherein the at least one memory and the computer program code are further configured to, with the at least one processor, cause the apparatus at least to:
generate a signal shaping factor control signal dependent on the signal shaping factor for each of the plurality of segments of the second audio signal.

54. The apparatus as claimed in claim 48, wherein the energy difference value is dependent on the energy of at least one segment from the first audio signal and the energy of at least one segment from the second audio signal.

55. The apparatus as claimed in claim 54, wherein the energy difference value is the ratio of the energy of at least one segment of the first audio signal to the energy of at least one segment of the second audio signal.

56. The apparatus as claimed in claim 47, wherein the first audio signal is an unprocessed audio signal, and wherein the second audio signal is a synthetic audio signal.

57. The apparatus as claimed in claim 47, wherein the first audio signal and the second audio signal are higher frequency audio signals.

58. An apparatus comprising:
at least one processor and at least one memory including computer program code, the at least one memory and the computer program code configured to, with the at least one processor, cause the apparatus at least to:
receive an encoded signal comprising at least in part a signal shaping factor signal;
decode the encoded signal to produce a synthetic audio signal;
determine at least one signal shaping factor for the synthetic signal from the received signal shaping factor signal; and
apply the at least one signal shaping factor to the synthetic audio signal.

59. The apparatus as claimed in claim 58, wherein the at least one memory and the computer program code are further configured to, with the at least one processor, cause the apparatus at least to:
partition the synthetic audio signal into a plurality of segments.

60. The apparatus as claimed in claim 59, wherein the segment is at least one of:
a time segment;
a frequency segment;
a time and frequency segment.

61. The apparatus as claimed in claim 59, wherein the at least one memory and the computer program code configured to, with the at least one processor, cause the apparatus at least to determine at least one signal shaping factor is further configured to cause the apparatus at least to:
determining at least one signal shaping factor for each one of the plurality of segments of the synthetic signal.

62. The apparatus as claimed in claim 59, wherein the at least one memory and the computer program code configured to, with the at least one processor, cause the apparatus at least to apply the at least one signal shaping factor to the synthetic audio signal is further configured to cause the apparatus at least to:
apply the at least one signal shaping factor for each one of the plurality of segments to the synthetic audio signal.

63. The apparatus as claimed in claim 58, wherein the at least one memory and the computer program code configured to, with the at least one processor, cause the apparatus at least to determine the at least one signal shaping factor function is further configured to cause the apparatus at least to:
decode at least one signal shaping factor from the signal shaping factor signal;
add the at least one signal shaping factor to a track of previous at least one signal shaping factor; and
interpolate the at least one signal shaping factor with the least one previous signal shaping factor from the track of signal shaping factors; and interpolating the previous signal shaping factor with the at least one signal shaping factor.
